(19) United States
(12) Patent Application Publication
(10) Pub. No.: US 2010/0291530 A1
(43) Pub. Date: Nov. 18, 2010

(54) Teaching and Learning Aid Including a Distinctively Shaped Mat

(76) Inventors: Jennifer Canter, Armonk, NY (US); Wade Canter, Armonk, NY (US)

Correspondence Address: FROMMER LAWRENCE & HAUG, 745 FIFTH AVENUE- 10TH FL., NEW YORK, NY, 10151, US

(21) Appl. No.: 12/467,429

(22) Filed: May 18, 2009

(51) Int. Cl. G09B 25/00

(52) U.S. Cl. 434/428

(57) ABSTRACT

An instructional aid comprises a mat shaped like a letter “U” and suitable, e.g., for placement on a floor. Pairs of cards may be provided for use with the mat. For example, one set may relate to “fruit,” and two cards in the set may bear matching pictures of apples, another pair may bear matching pictures of bananas, etc. The mat may comprise spaces, e.g., for placing such cards, and in one embodiment, the spaces may be clear pockets, corresponding to the size of the cards. Some embodiments of the invention may encourage, e.g., active play between a caregiver and a preschool-age child, stimulating, e.g., social interaction and development of the child's ability to speak and understand. Examples of such active play may include matching games, but are not limited to such games.

### COPYRIGHT NOTICE

A portion of the disclosure of this patent document contains material that is subject to copyright protection. The copyright owner has no objection to the facsimile reproduction by anyone of the patent document or the patent disclosure as it appears in the Patent and Trademark Office patent files or records, but otherwise reserves all copyrights whatsoever.

### BACKGROUND

Active play with babies and toddlers stimulates their social interaction, speech development, and attachment with their caregivers. Fun, interactive activities on the floor are an excellent way to stimulate a baby or toddler and engage in active play. With or without modification, moreover, some kinds of apparatus useful for active play with children may also aid the cognitive development of persons of all ages.

### BRIEF SUMMARY OF THE INVENTION

The invention relates to an instructional aid, e.g., for toddlers and children of preschool age. Embodiments of the invention comprise a mat shaped like a letter “U” and suitable for laying flat, e.g., on a floor or similar surface. The dimensions of a mat according to an embodiment of the invention may be selected such that a child may sit between the arms of the “U” without sitting on any part of the mat itself, yet at the same time being capable of reaching objects placed anywhere, or nearly anywhere, on the mat.

A mat according to an embodiment of the invention may have distinct upper and lower surfaces. The upper surface may be suitable for holding one or more objects: for example, one or more spaces may be provided for holding, e.g., rectangular cards. In such an embodiment, these spaces may take the form of, for example, marked spaces on the mat, pockets (including, e.g., clear plastic pockets) capable of holding cards, or elastic straps configured to hold cards to the mat, among other possibilities.

In an embodiment of the invention, cards for use with a mat such as described above are provided in sets, where each set comprises a plurality of matched pairs of cards. In such an embodiment of the invention, one card from each pair may be placed on the mat, while the corresponding cards are used by the instructor, caregiver, or other person who conducts an instructional activity with the child. Cards in a single set may all relate to a common theme, e.g., fruits, toys, vehicles, things in the neighborhood, etc.

A mat according to an embodiment of the invention may be accompanied by one or more sets of cards. Cards within a single set may bear common indicia—for example, the backs of the cards within a single set may have the same colors, designs, or both—that distinguish that set from others meant for use with the mat.

In an embodiment of the invention, an instructional aid comprises a U-shaped mat with a plurality of designated spaces, where each space is designated for holding a card. In an embodiment of the invention, at least five of the spaces are provided. In any reference herein to a space designated for receiving or holding a card, “designated” is used in a broad sense and may include, for example, indicia that a space is intended for a card, means for securing a card at that location, or both.

In an embodiment of the invention, the body of the “U” described by the mat is between six and twenty-four inches wide, and the space between the arms of the “U” is between twelve and thirty inches wide at a point of greatest distance.

In an embodiment of the invention, the designation of a space for holding a card includes a pocket on the upwards-facing surface of the mat, where the size of the pocket corresponds to the size of the card. Each pocket, according to an embodiment of the invention, comprises a piece of substantially transparent plastic that is affixed to the upward-facing surface of the mat.

In an embodiment of the invention, the designation of a space for holding a card comprises a pair of elastic straps affixed to the mat, where the straps of each pair are affixed to the upward-facing surface of the mat and placed so that the straps of each pair can together hold a single card of the upward-facing surface of the mat by pressing against diagonally opposed corners of the card.

According to embodiments of the invention, any of the foregoing embodiments of the invention may be provided with one or more sets of cards, where each set may comprise a plurality of pairs of cards. The number of pairs in each set may equal the number of spaces designated on the mat, and at least one of the cards of each pair may have a size that corresponds to the size of the designated spaces. Each card of a pair may bear on at least one side visual indicia, such as a picture of an object, that the cards of a pair are members of the same pair and distinguishing the cards of that pair from the cards of all other pairs.

In an embodiment of the invention, an apparatus is provided for aiding in instruction. In such an embodiment, the provided apparatus comprises a U-shaped mat and a U-shaped cover for the mat. The cover may bear a plurality of images, where each image depicts a different object.

In an embodiment of the invention, the mat and the cover may comprise a plurality of corresponding fasteners, which may be configured so that, when all corresponding fasteners are fastened to each other, the cover is removably joined to the mat so that, when the mat lies substantially flat upon a surface, the cover lies substantially flat upon the mat.

In another embodiment of the invention, the cover is designed to enclose the mat. In such an embodiment, the cover comprises an opening, and the cover is configured to be capable of having the mat inserted into the cover so that the cover entirely encloses the mat.

In an embodiment of the invention, an apparatus comprising a U-shaped mat and a U-shaped cover comprises a plurality of cards, where each of the cards corresponds uniquely to one of the objects depicted on the cover.

### BRIEF DESCRIPTION OF THE DRAWINGS

The invention is illustrated in the figures of the accompanying drawings, which are meant to be exemplary and not limiting, and in which like references are intended to refer to like or corresponding things.

FIG. 1 depicts a mat according to an embodiment of the invention, viewed from above.

FIG. 2 depicts a cross-section of a mat according to an embodiment of the invention.

FIG. 3 depicts a pocket on the upper surface of a mat according to an embodiment of the invention.

FIG. 4 depicts a face of a card for use, e.g., with a mat according to an embodiment of the invention.

FIG. 5 depicts the flow of an educational game according to an embodiment of the invention.

FIG. 6 depicts the flow of an educational game according to an embodiment of the invention.

FIG. 7 depicts the flow of an educational game according to an embodiment of the invention.

### DETAILED DESCRIPTION OF THE PREFERRED EMBODIMENTS

Embodiments of the invention may include objects intended for use in developing cognitive abilities of a subject, including those of young children, especially toddlers and children of preschool age. The use of the objects may be directed, e.g., by a teacher, a parent or other caregiver, or other person using the objects with the subject and directing the interaction. The term “instructor” is used in a broad sense herein and is intended to include any such person using the objects with the subject, in connection with one or more embodiments of the invention.

Because embodiments of the invention discussed herein may be intended for use with children as subjects, a subject using a mat with an instructor may be referred to herein as a “child.” This reference is intended to be illustrative, however, and does not in any way limit the generality of any invention described herein. An instructor may use objects according to an embodiment of the invention with any person of any age who may be believed to benefit from the activities.

According to an embodiment of the invention, a play mat is provided. The mat may be intended for use on a floor or other firm, roughly flat surface, and may be capable of lying flat or substantially flat on that surface during ordinary use. The size and shape of the play mat may be selected so that neither the instructor nor the subject needs to change location, e.g., while sitting on the floor, to easily reach substantially any portion of the upper surface of the mat, while neither the instructor nor the subject sits on or above any part of the mat. For example, a mat in an embodiment of the invention may be linear or rectangular and may be placed on the floor between the instructor and the subject.

Alternatively, a mat according to an embodiment of the invention may curve, bend, or both, e.g., around one or both of the instructor and the subject. For example, a mat in an embodiment of the invention may have the shape, e.g., of two lines joined at a right angle. In connection with such an embodiment, the subject may sit on the floor between the two lines, while the apex of the angle points at the instructor.

In an embodiment of the invention, a mat may be, e.g., semicircular. In connection with such an embodiment, the subject may sit, e.g., inside the circle that the mat partially describes, and the instructor may sit outside. A mat according to an embodiment of the invention may describe a greater or lesser portion of a circle than a semicircle, and may be used, e.g., as described in connection with the semicircular mat.

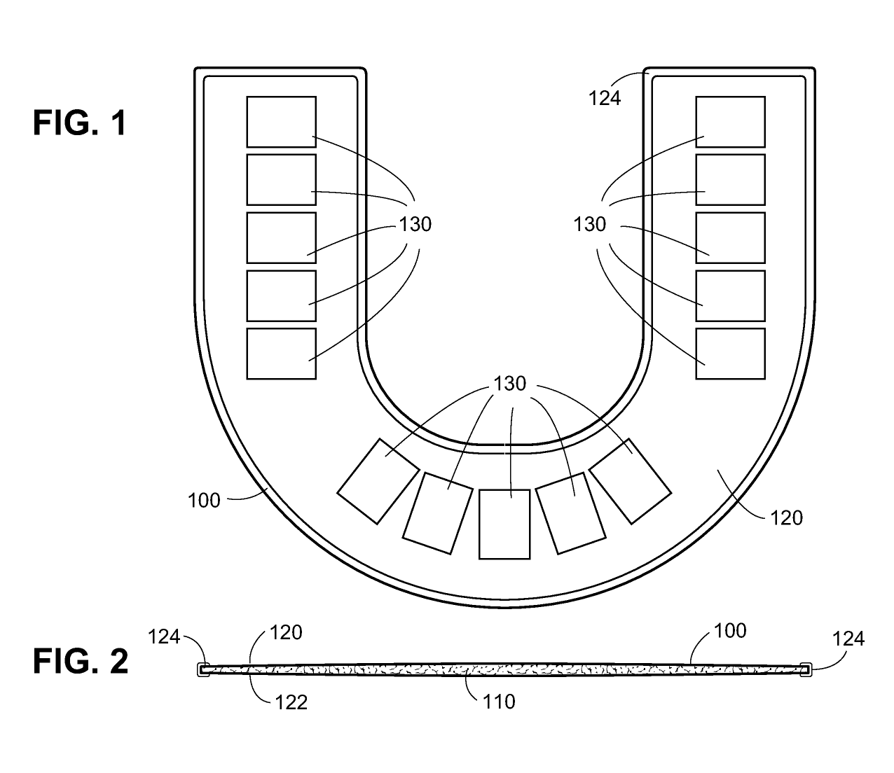

FIG. 1 is a view from above of a U-shaped play mat 100 according to an embodiment of the invention. In connection with such an embodiment, a child or other subject may sit between the arms of the “U” without covering any part of the mat. Simultaneously, however, the child may manipulate objects that are in contact with the surface of the mat, as described in more detail below. Therefore, in an embodiment of the invention, the dimensions of the mat may be chosen to reflect the expected size of the child, e.g., by creating a large enough space between the arms of the “U” that a sitting child might fit comfortably between the arms, while also being able to reach easily objects on the mat.

For example, in the embodiment of the invention that FIG. 1 depicts, the U-shaped play mat 100, which may be intended for use, e.g., with a child of preschool age, is approximately twelve inches wide at all points, with a distance of approximately twenty inches between the inner edges of the arms of the “U”. Consequently, the total extent of the mat 100 at its widest point is approximately forty-four inches.

As depicted in FIG. 1, the mat 100 is approximately thirty-six inches deep at its widest point. As described above, the width of the “U” is approximately twelve inches, which means that the maximum depth of the cut-out between the arms is approximately twenty-four inches.

The dimensions of the mat depicted in FIG. 1 are illustrative. Mats intended for use with children may be sized, for example, so that the space between the arms of the “U” is between twelve and thirty inches, according to some exemplary embodiments of the invention. Similarly, the width of the body of the “U” may vary from, e.g., six to twenty-four inches, according to some exemplary embodiments of the invention. Other dimensions of a mat in an embodiment of the invention may vary correspondingly. A mat intended for use, e.g., with an adolescent or adult may in an embodiment of the invention have one or more dimensions that depart from these ranges.

According to an embodiment of the invention, the mat 100 is filled with a soft material 110, such as, e.g., foam or cotton batting. FIG. 2 depicts a horizontal cross-section of a mat 100 according to such an embodiment of the invention. The mat 100 as depicted in FIG. 2 comprises a shell, made, e.g., out of two layers 120, 122 of U-shaped fabric that are sewn together around the edges.

In the depicted embodiment, the edges of the mat 100 are trimmed or covered by another thin strip 124 of fabric sewn around the perimeter of the mat 100, which may, e.g., reinforce the seam or protect the edges from excessive wear, fraying, or both. In an alternative embodiment of the invention (not depicted), the trimming may be absent.

In an embodiment of the invention such as FIG. 1 depicts, the upper surface of the mat 100 may comprise one or more pockets 130, formed, e.g., by sewing or otherwise affixing clear plastic rectangles by three out of four sides to the upper shell 120. The dimensions of each pocket may, in an embodiment of the invention, be chosen to correspond to cards, such as those described below, intended for use with the play mat 100, and each of the pockets may be considered to designate a location that may receive a card. In such an embodiment, the dimensions of the pocket, and consequently of the plastic, may be chosen so that a child or an adult may insert a card into and remove a card from each pocket without undue difficulty, but also so that the pocket will keep an inserted card in substantially the same place, relative to the surface of the mat 100, until the card is intentionally removed.

For example, as FIG. 1 depicts, a mat 100 according to an embodiment of the invention comprises fifteen pockets 130 on its upper surface. The pockets are substantially evenly spaced on each arm and the bottom of the “U”, with five pockets 130 evenly spaced in each location. In the depicted embodiment of the invention, each pocket 130 is formed by sewing three edges of a rectangular piece of transparent PVC to the upper shell 120 of the mat 100. The depicted pockets open towards the outside of the “U,” away from the child, reducing the likelihood that any card will be pulled from its pocket by the child.

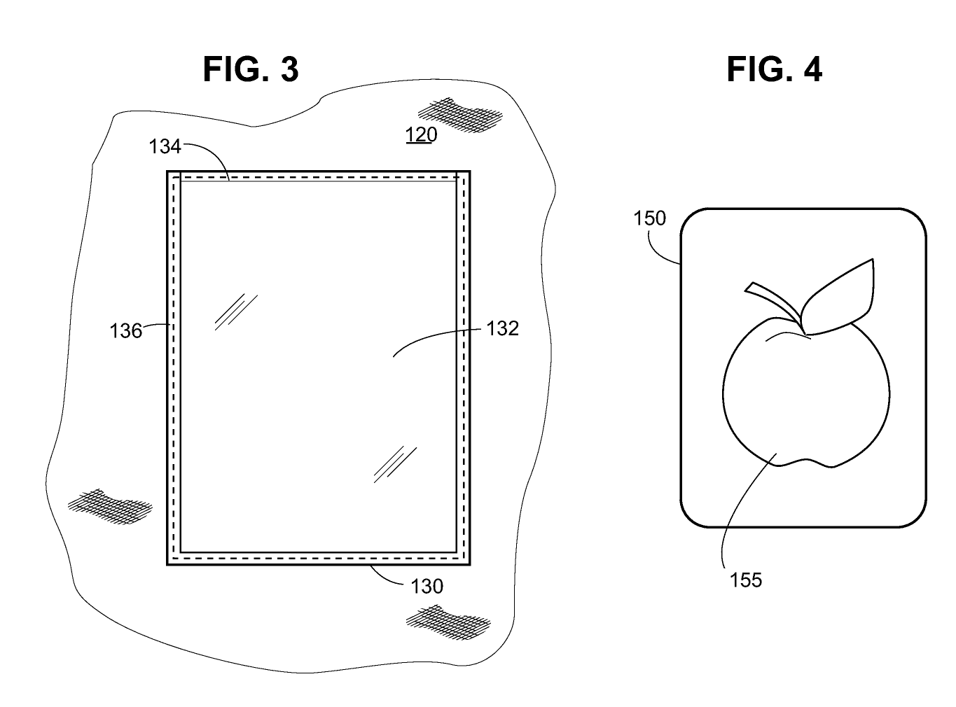

FIG. 3 depicts in more detail a pocket 130 sewn to the upper surface of a mat 120 in an embodiment of the invention. As FIG. 3 depicts, a rectangular piece of transparent material 132, for example, PVC, is the outside layer of the pocket 130.

As depicted in FIG. 3, a sheet of opaque material 134 underlies the transparent material 132, and this opaque sheet 132 may, e.g., make the pocket easier to see and/or make inserting and/or removing cards easier. Depending on the intended purpose or purposes of the opaque sheet 132, it may be made of any suitable material, including, but not limited to, fabrics made of natural and/or synthetic fibers, plastic, and/or coated or uncoated card stock.

In an embodiment of the invention, the opaque material 134 is approximately the size of the transparent material 132 in one dimension and is slightly longer than the transparent material 132 in the other dimension. In such an embodiment of the invention, the sheet 134 may be aligned on three edges with the transparent cover 132 of the pocket, with a portion of the opaque sheet 134 protruding from the transparent cover 132. The protruding side of the opaque sheet 134 may coincide with the opening of the pocket 130, and the cover 132 may be joined to the opaque sheet 134, e.g., by stitching and/or other means. For example, in an embodiment of the invention such as FIG. 3 depicts, stitching secures the transparent cover 132, through the opaque sheet 134, to the upper surface 120 (FIG. 2) of the mat along three sides of the pocket 130, but joins only the opaque sheet 134 to the upper surface 120 of the mat on the fourth side.

An embodiment of the invention may include a strip of trim 136 around one or more edges of the pocket 130, and the trim may, e.g., protect the edges of the pocket 130 and/or one or more of the materials that comprise the pocket. In an embodiment of the invention (not pictured), the trim may be absent.

In an embodiment of the invention (not pictured), the opaque sheet 134 may be absent.

A mat according to an embodiment of the invention may be intended for use on a floor or other surface upon which the mat may be prone to slipping. To counter any such tendency, a mat according to an embodiment of the invention may comprise anti-slip material (not pictured) affixed, e.g., to the underside of the mat or to one or more portions of it. Anti-slip materials according to an embodiment of the invention may include, e.g., rubber or vinyl in, e.g., strips, dots, or other shapes, which may be, e.g., sewn, glued, fused, or otherwise affixed to the lower surface of the mat. Other suitable materials and configurations for reducing any tendency towards sliding will be readily apparent to those skilled in the relevant art.

FIG. 4 depicts one face of a rectangular card 150 for use, e.g., with a mat 100 (FIG. 1) such as described above, according to an embodiment of the invention. The dimensions of the card may be chosen, e.g., to correspond to the size of the pockets 130 (FIG. 1) on the upper surface of the mat 100 (FIG. 1). For example, in an embodiment of the invention, the depicted card is four inches wide and six inches high.

A card 150 in connection with an embodiment of the invention may be a part of a set of cards. For example, a set of cards 150 may be a set of pairs of cards 150, and the number of pairs in a set may, e.g., be the same as the number of pockets in the mat 100 (FIG. 1) intended for use with the cards 150 or may be a different number.

The cards may bear pictures or other marks. For example, the card 150 depicted in FIG. 4 has a picture 155 of an apple on the depicted face.

In an embodiment of the invention, the cards in each respective pair may be identical to one another but different from all other cards in the set. In an alternative embodiment of the invention, the cards in each pair may share a relationship with one another that they do not share with any other card. For example, one card in each pair may display a picture of an object unique to the set, while the other card (not pictured) may show the name of the object. A card paired with the card 150 depicted in FIG. 4, for example, might show the word “apple.”

In other embodiments of the invention, the cards in a pair may display objects that are related to one another. For example, one card (not pictured) in a pair may depict, e.g., a fire fighter's helmet, while its counterpart (not pictured) depicts a fire engine. In an embodiment of the invention, no other card in the set depicts an object with an apparent relationship to fire fighting.

Depending on the embodiment of the invention, the cards in each pair may or may not have the same size, shape, or both. For example, in an embodiment of the invention, one card in each pair may have a size and shape suited for placement on or in a mat as described below, while the corresponding card in each pair may have a size and shape convenient for handling by the instructor, the child, or both.

Sets of cards may be distinguished from one another in various ways. For example, in an embodiment of the invention, all cards in a set may have identical or corresponding backs (not pictured), which may differ from the backs of cards of different sets. Card backs may use, for example, one or more of color, patterns, and images to indicate membership in a card set.

A mat 100 (FIG. 1) and one or more sets of cards 150 (FIG. 4), e.g., for use with the mat 100, may be provided together.

An instructor and a child may conduct many different activities (which may be referred to as “games”) with a mat and one or more sets of cards according to embodiments of the invention. Several games are described as examples below. But this description is intended to be illustrative and not limiting, and variations of the following games and other, entirely different activities may involve a mat and cards according to an embodiment of the invention.

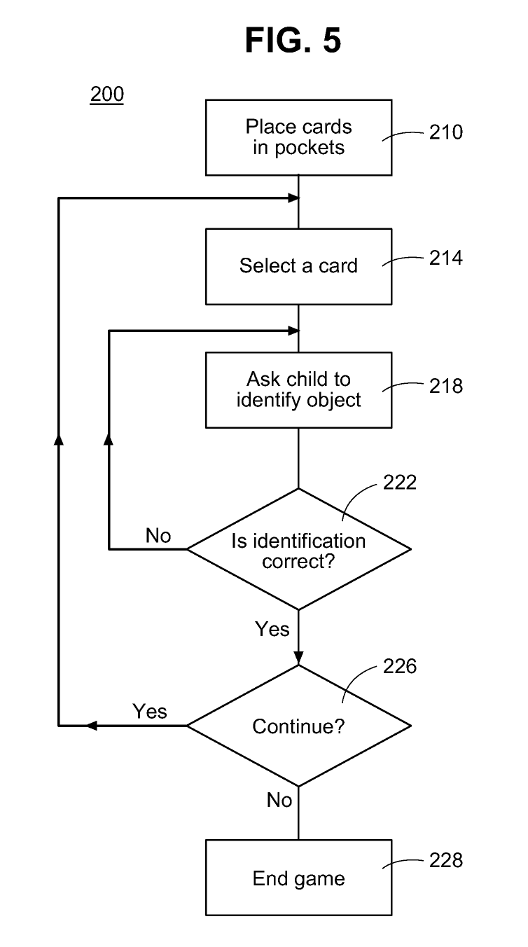

FIG. 5 depicts the flow 200 of one such game in connection with an embodiment of the invention. In block 210, the instructor first places one card 150 (FIG. 4) from each pair in the set in each pocket 130 (FIG. 1) of the mat 100 (FIG. 1). In a variants of this game, the instructor does not fill all the pockets. For example, in one variation that may be appropriate, e.g., for the youngest children, the instructor uses only two or three cards.

After placing the cards, the instructor selects a card in block 214 and then asks the child to identify the object that the card depicts in block 218. If the child incorrectly identifies the object, the instructor may, as block 222 illustrates, return to block 218, asking the child again to depict the identified object.

If the child correctly identifies the object, in connection with an embodiment of the invention, the instructor may decide in block 226 whether to continue the game. If the instructor wishes to continue, the game returns to block 214, in which the instructor selects a card. If not, the game ends at block 228.

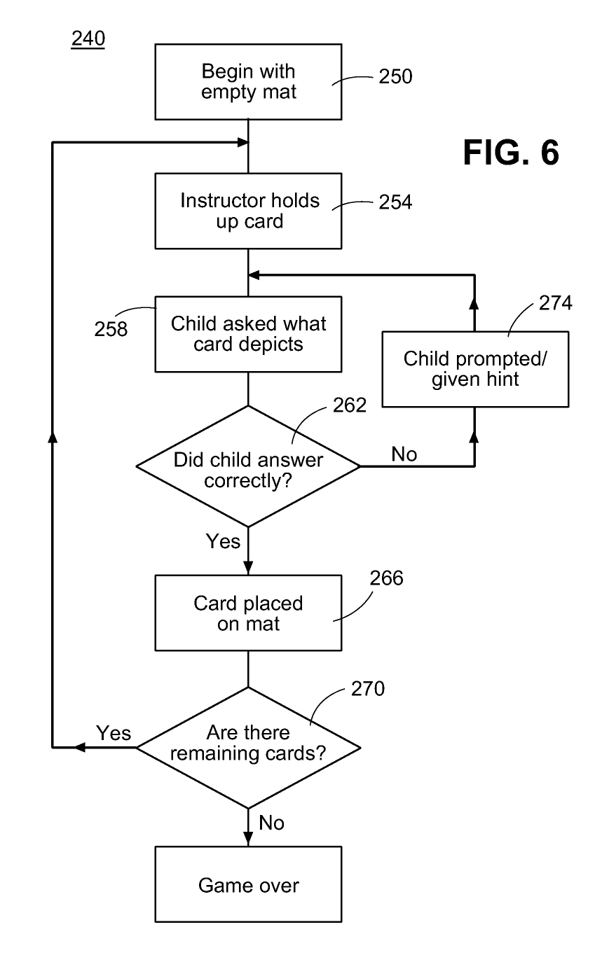

FIG. 6 depicts the flow 240 of another game in connection with an embodiment of the invention, this game using only one card from each pair in a set. The game begins in block 250 with the mat 100 empty of cards. In block 254, the instructor holds up a card and, in block 258, asks the child what the card depicts. If the child answers correctly in block 262, the instructor puts the card into an empty pocket in the mat in block 266, and then, if any cards remain in block 270, the instructor returns to block 254 and holds up another card. If the child answers incorrectly in block 262, however, the instructor may prompt the child and/or provide a hint in block 274 and then return to block 258, asking the child again what the card depicts. The game may continue until all cards have been reviewed.

In variants of the game in that FIG. 6 depicts, which may be most appropriate, e.g., for the youngest children, the instructor may model the correct word for the child (not pictured). For example, if a card shows a picture of an apple, the instructor may say something like: “This is an apple. Say ‘apple.’” In a different variant (not pictured), which may be most appropriate, e.g., for slightly older children, the instructor may provide only a phonemic cue that may comprise, e.g., saying the initial sound of the correct word.

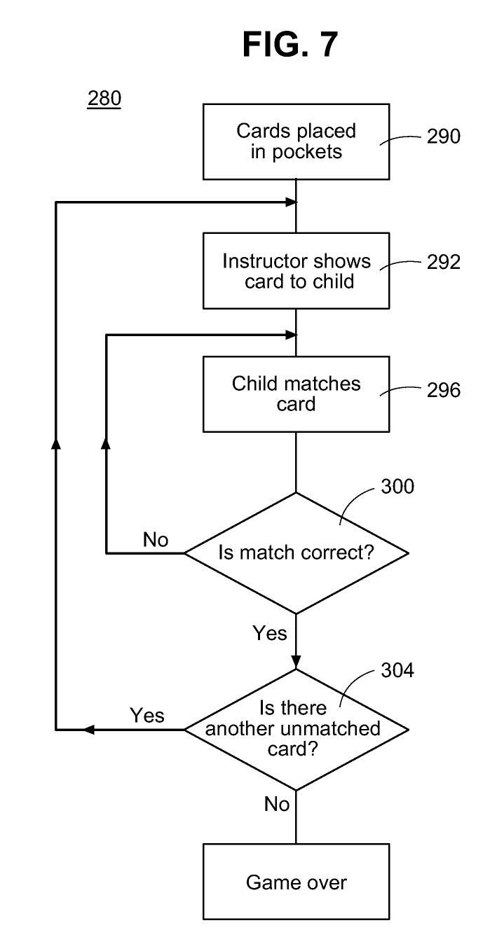

FIG. 7 depicts the flow 280 of another game in connection with an embodiment of the invention. This game is a matching game and begins in block 290 with the instructor placing one card from each pair in a set into each of the pockets in the mat. The instructor then, in block 292, takes one of the other cards in set, shows it to the child, and asks the child to find a match. On matching the card in block 296, the child puts the card on top of the matching card that is already in the pocket in the mat. (Generally, this may mean that the child puts the card on top of the plastic that forms that pocket that holds the matching card.)

In block 300, the instructor determines whether the child correctly identified a match in block 296. If the match is correct, then, if in block 304 it is found that there are cards left, the instructor returns to block 292, selecting another card and showing it to the child. If the match is incorrect, the instructor returns to block 296, and the child may try again to find the match. This game may continue until it is found in block 304 that all cards have been matched.

Other games (not pictured) may, in connection with an embodiment of the invention, advance the child's ability to speak. In one such game, for example, one card from each pair in a set of cards may be placed on the mat, and the child may then be prompted to ask for a desired matching card. At first, the instructor may give the child model phrases, such as “more, please,” “I want more,” “give me,” etc. As the child progresses, the instructor may rely less on such models and instead give phonemic or visual cues. In such a game, once the child receives a requested card, the instructor may tell the child to put the card atop the matching card on the mat.

Embodiments of the invention may involve differently configured mats. For example, a mat (not pictured) according to an embodiment of the invention may be, e.g., a U-shaped sheet of flat fabric or plastic instead of, as described above, a shell containing a layer of padding. Depending on the embodiment of the invention, some or all edges of such a single-layer mat may or may not be trimmed, finished, or otherwise protected against wear. Depending on the embodiment of the invention, such a mat may or may not have an anti-skid material attached to the underside.

In an embodiment of the invention, the plastic that forms the pockets may be attached to the upper surface of the mat in some way other than stitching. For example, the plastic may be fused, glued, or otherwise bonded along three sides to the upper surface of the mat. Any such form of attachment may be used in connection with any mat construction with which the attachment is compatible. For example, in an embodiment of the invention, a bonded pocket may be used with, e.g., a mat that may be a single sheet of PVC or other plastic, or it may be a filled mat with a top layer of PVC or other plastic.

In an embodiment of the invention (not pictured), the pocket need not have a rectangular shape. In an embodiment of the invention, for example, the pocket may be formed by affixing, e.g., a semicircular piece of transparent PVC to the upper surface of the mat. A mat so constructed may in an embodiment of the invention be used with cards that have a shape that corresponds to the shape of the pocket. For example, a mat with semicircular pockets may be intended for use with circular cards.

In another embodiment of the invention, for example, triangular sheets of transparent PVC or other material may be used to form triangular pockets, which may be intended for use with, e.g., triangular cards. Such triangular pockets may also be intended to hold, e.g., square or rectangular cards, e.g., by their corners. In an embodiment of the invention, two triangular pockets may be provided for each space on the mat for which placement of a card is designated, with each pair of pockets configured to hold a single, e.g., square or rectangular card to the mat by opposed corners.

Cards intended for use with a mat according to an embodiment of the invention may have any size and any shape consistent with the intended use. The size and shape of the cards may be such that an adult can handle the cards conveniently, and the cards may be large enough that the image or other information on each card may be clearly visible to both the child and the instructor. The cards may be made of any material sufficiently durable and flexible for the intended use with a mat as described herein. Examples of such materials according to embodiments of the invention include, without limitation, coated and uncoated card stock and plastic.

The size, shape, and/or configuration of the pockets may in an embodiment of the invention correspond to the cards intended for use with the mat. In an embodiment of the invention, the pockets may be configured so that, e.g., cards may be conveniently inserted and removed, e.g., by the instructor, but the cards in a pocket tend to remain in substantially the same position relative to the mat during a game except when intentionally moved.

In an embodiment of the invention, cards may be held to the upper surface of the mat, e.g., in a plurality of designated locations, in a manner other than through the use of pockets. For example, in an embodiment of the invention, each position on the upper surface of the mat that is designated to receive a card may have one or more elastic straps (not pictured) attached to the upper surface of the mat, configured, e.g., to hold a card in place by its corners. Cards may be inserted, removed, or both by stretching one or more straps out of the way, bending the card, or both.

In an embodiment of the invention, each position on the surface of the mat that is designated to receive a card contains a magnet in some way. For example, the magnet may be sewn into a small pocket in the mat, or glued or otherwise affixed to the mat, and the cards may comprise a material that is attracted to magnets. In an alternative embodiment of the invention, the cards may be made of or comprise a material that exhibits magnetism, and the mat may contain a material that is attracted to magnets.

Alternatively, the upper surface of the mat may not be configured to retain the cards, but may simply provide indicia of the locations designated for the cards. In connection with such an embodiment, cards may rest on the surface of the mat without being effectively secured against movement. For example, in an embodiment of the invention, a solid, dashed, or dotted outline (not pictured), e.g., of a card, indicates where each card is to be placed. In an embodiment of the invention a shape, e.g., a circle, cross, triangle, or star marks each location on the surface of the mat that is designated to receive a card.

Instead of or in addition to an outline or other visual indicia, in an embodiment of the invention, tactile indicia may be provided. For example, the outline may be sewn into the surface of the mat, it may be printed, e.g., with raised ink, embroidery, and/or use of another material distinguishable by touch may indicate each position designated to receive a card.

In an embodiment of the invention, a mat may be used with objects other than cards. For example, a mat according to an embodiment of the invention may comprise a plurality of hook-and-loop fasteners affixed, e.g., sewn or glued, to its upper surface. A plurality of objects may be provided, e.g., corresponding to the number of fasteners affixed to the mat surface. The provided objects may also comprise hook-and-loop fasteners that correspond to the fasteners on the upper surface of the mat. In an embodiment of the invention, the provided objects may be, e.g., models or replicas of objects such as may be depicted on cards according to one of the embodiments of the invention described above.

In connection with such an embodiment of the invention, a game may comprise placing some or all of the objects on the mat, e.g., so that the fasteners on the mat join with the fasteners on the respective objects to secure the objects to the mat. It will be apparent that objects in an embodiments of the invention may be used, e.g., in appropriately modified versions of the games described herein involving cards and/or pairs of associated cards.

In an embodiment of the invention, a play mat may be used with a replaceable cover. For example, a cover may be configured to cover some or all of the top surface of the mat. According to embodiments of the invention, such a cover may be secured to the mat, e.g., by hook-and-loop fasteners, zippers, or snaps, or by any other means or combination of means that may secure a selected cover to the mat during expected use but allows removal and replacement of the cover without undue difficulty. In an embodiment of the invention, some or all fasteners may be affixed to the underside of the mat, and the cover may be configured so that portions of the cover may wrap around one or more edges of the mat, thereby allowing fasteners on the cover to connect to the corresponding fasteners on the mat.

In an embodiment of the invention, a cover may be designed so that it may contain all or substantially all of the mat. A cover according to such an embodiment may comprise an opening though which a mat may be inserted and removed. Such a cover may be designed so that the shape of the mat and the friction between the outer surface of the mat and the inner surface of the cover suffice to keep the mat inside the cover. Alternatively, in an embodiment of the invention, a cover may use, e.g., hook-and-loop fasteners, zippers, and/or snaps, and/or other fasteners to keep the opening closed or substantially closed.

A cover according to an embodiment of the invention may have an upper surface, e.g., such as described above as comprised by a mat. For example, a mat cover in an embodiment of the invention may comprise pockets configured to receive cards.

In an embodiment of the invention, instead of or in addition to comprising pockets and/or one or more means for holding cards and/or other objects, the upper surface of a mat may comprise, e.g., printed or otherwise applied words, images, and/or tactile indicia that respectively correspond to a plurality of cards and/or object. In an embodiment of the invention that comprises such a cover, the images, words, and/or tactile indicia on the cover may replace or supplement one set of cards, objects, or both, such as may be used in connection with an embodiment of the invention that does such comprise such a cover, e.g., as described above.

For example, a cover in an embodiment of the invention may depict different fruits and may be accompanied by a plurality of cards, where each card depicts one of the fruits depicted on the mat. In a matching game in connection with an embodiment of the invention, the instructor may direct the subject to match the fruit on a given card with the corresponding fruit on the cover. Other games, including but not limited to those described herein in connection with FIGS. 5-7, may be modified to use a mat with, e.g., such a cover according to an embodiment of the invention.

Although the invention has been illustrated by embodiments that comprise mats that may be used, e.g., on a floor, embodiments of the invention may comprise a mat configured for use in other situations. For example, a mat according to an embodiment of the invention may have a size and/or shape intended for use, e.g., while the instructor and the subject sit in chairs at a table. In one exemplary embodiment of the invention, a mat for, e.g., tabletop use, may be rectangular and, for example, 24 inches wide and 5 inches deep. Mats intended for tabletop use may in embodiments of the invention have other sizes and shapes that are consistent with the intended use of the mat, e.g., as described herein. For example, a tabletop mat may in an embodiment of the invention be angular, semicircular, or U-shaped, among other possibilities. Cards for use with such a mat in an embodiment of the invention may have a size corresponding to the size of the mat: for example, cards intended for use with a tabletop mat having the above dimensions may be, e.g., 2.5 inches wide and 4 inches high.

The invention is described herein in terms of certain exemplary embodiments. This description is intended to by illustrative and not limiting, and the scope of the claims is intended to be delimited by the wording of the claims themselves. Other embodiments of the invention, including but not limited to variants of the described embodiments, will be apparent to those skilled in the relevant arts.

1. An instructional aid comprising:
a U-shaped mat with a plurality of designated spaces thereon, each space being designated for holding a card.

2. The instructional aid of claim 1, wherein the plurality of designated spaces comprises at least five of the designated spaces.

3. The instructional aid of claim 1, wherein the body of the “U” described by the mat is between six and twenty-four inches wide, and the space between the arms of the “U” is between twelve and thirty inches wide at a point of greatest distance.

4. The instructional aid of claim 1, wherein the designation of a space for holding a card consists of a pocket on the upwards facing surface of the mat, the size of the pocket corresponding to the size of the card.

5. The instructional aid of claim 4, wherein each pocket comprises a piece of substantially transparent plastic that is affixed to the upward-facing surface of the mat.

6. The instructional aid of claim 1, wherein the designation of a space for holding a card comprises a pair of elastic straps affixed to the mat, the straps of each pair being affixed to the upward-facing surface of the mat and placed so that the straps of each pair are capable of together securing a single card of the upward-facing surface of the mat by pressing against diagonally opposed corners of the card.

7. An apparatus for aiding in instruction, comprising:
a U-shaped mat with a plurality of designated spaces thereon, each space being designated for holding a card; and
a set of cards that comprises a plurality of pairs of cards, the number of pairs being equal to the number of spaces designated on the mat, at least one of the cards of each pair having a size that corresponds to the size of the designated spaces, and each card of a pair bearing on at least one side a visual indicia that the cards of a pair are members of the same pair and distinguishing the cards of that pair from the cards of all other pairs.

8. The apparatus of claim 7, wherein the plurality of designated spaces comprises at least five of the designated spaces.

9. The apparatus of claim 7, wherein the designation of a space for holding a card consists of a pocket on the upwards facing surface of the mat, the size of the pocket corresponding to the size of the card.

10. The apparatus of claim 9, wherein each pocket comprises a piece of substantially transparent plastic that is affixed to the upward-facing surface of the mat.

11. The apparatus of claim 7, wherein the designation of a space for holding a card comprises of a pair of elastic straps affixed to the mat, the straps of each pair being affixed to the upward-facing surface of the mat and placed so that the straps of each pair are capable of together securing a single card of the upward-facing surface of the mat by pressing against diagonally opposed corners of the card.

12. An apparatus for aiding in instruction, comprising:
a U-shaped mat; and
a U-shaped cover for the mat, the cover bearing a plurality of images, each image depicting a different object.

13. The apparatus of claim 12, wherein:
the mat comprises a plurality of fasteners;
the cover comprises a plurality of fasteners, each of the fasteners comprised by the cover corresponding to a respective fastener comprised by the mat; and
the fasteners comprised by the mat and the fasteners comprised by the cover are configured so that, when all corresponding fasteners are fastened to each other, the cover is removably joined to the mat so that, when the mat lies substantially flat upon a surface, the cover lies substantially flat upon the mat.

14. The apparatus of claim 12, wherein:
the cover comprises an opening; and
the cover is configured to be capable of having the mat inserted into the cover so that the cover entirely encloses the mat.

15. The apparatus of claim 12, comprising a plurality of cards, each of the cards corresponding uniquely to one of the objects depicted on the cover.
